(19) United States
(12) Patent Application Publication
(10) Pub. No.: US 2008/0108035 A1
(43) Pub. Date: May 8, 2008

(54) PERPETUAL EDUCATIONAL SYSTEM PROVIDING CONTINUOUS, PERSONALIZED LEARNING SESSIONS BASED ON A COMPREHENSIVE KNOWLEDGE BASE

(75) Inventor: Roswitha Warda, Sebastopol, CA (US)

Correspondence Address: ESPINDLE LEARNING, P.O. BOX 338, 10330 BODEGE HWY, SEBASTOPOI, CA, 95472, US

(73) Assignee: ESPINDLE LEARNING, Sebastopol, CA (US)

(21) Appl. No.: 11/531,393

(22) Filed: Sep. 13, 2006

(51) Int. Cl. G09B 7/00; G09B 3/00

(52) U.S. Cl. 434/335; 434/362; 434/322

(57) ABSTRACT

A perpetual software-application that provides customized, ongoing and unlimited tutoring based on a database designed to provide a comprehensive knowledge resource for the area of study and a user database that maintains a individual learning profile on a continuous basis, designing personalized learning quizzes based on the student's preferences, needs and prior quiz data.

### FIELD OF THE INVENTION

The present invention relates to software-based instruction and, more particularly, to providing perpetual tutoring based on the individual's skill level, goals, needs and prior performance and supporting this continuous process by linking to an extensive knowledge base.

### BACKGROUND OF THE INVENTION

Various learning processes are needed as a student acquires a solid education: Creative, cognitive, social, repetitive and memory-based learning processes, among others, come together to develop the brain's capacities and to form a broad education.

The hardest and most frequently neglected components of a good education are the repetitive and memory-based learning steps, because they demand large amounts of time and resources and require an effective learning strategy to be successful.

These learning steps are frequently the foundation of other learning steps. Insufficiencies in these areas often affect our educational goals negatively and are hard to remedy.

For millennia, students, teachers and parents have been struggling with these tasks, knowing that they are important but not having a tool at hand that would truly manage the process effectively and efficiently.

A large range of subject areas are memory-based and require repetitive learning tasks. These and similar tasks can be improved through comprehensive tutoring technology: English spelling, word recognition and vocabulary (see http://www.eSpindle.org), grammar, prepositions and punctuation, facts of the social and natural sciences (geography, history, physics, chemistry, etc.), math routines, preparation for comprehensive tests (medicine, law, etc.) and many more.

Time, resources and proper technique, however, often limit how diligently learning material is repeated and memorized. While everyone can learn everything if time and resources are available and an effective teaching method is applied, such support is hardly ever sufficiently available through traditional means of instruction.

Managing the learning process and collecting and maintaining data of what is learned and what needs further practice by each individual is very time consuming, if done in the traditional way. The learning experience often depends on the support of other people (teacher, tutor, parent etc.), creating another obstacle to learning success since many students do not have such support available to them.

Static learning programs such as books, tapes etc. do not include individualization, but simply present the subject matter.

Even classroom instruction or live tutoring can provide only limited customized follow-up. What is known and what needs repetition is hard to manage and supervise by traditional means, which frequently results in a not maintained and incomplete learning cycle, and unlearned subject matter.

As the brain learns new content or learns to replace a wrong assumption with a correct one, carefully timed repetitions are needed to make sure the new understanding is actually anchored in long-term memory.

### Especially where the brain already holds an assumption, one repetition is hardly ever enough to overwrite the wrong information.

The number of optimal repetitions may vary from subject to subject, and should be evaluated and tested before launching a new tutoring module.

To find the best schedule for our spelling tutorial at http://www.eSpindle.org we conducted an informal study with a range of teachers and tutors, asking them how many times, based on their teaching experience, a student needed to repeat material that was previously unknown or learned incorrectly.

The statements of these professionals indicated that most students learn previously unknown words upon the first or second exposure. Words that were learned incorrectly nearly always need at least 3 repetitions to erase the previous Mental Orthographic Images (MOI)—the brains way to determine what “looks right.”

We then verified these findings by comparing long-term (1 month) retention for two, three and four repetitions. It became obvious that two repetitions were often not enough to secure long-term learning. The retention rate for three and four repetitions were nearly identical, which is why the current eSpindle spelling tutorial requires three correct repetitions before a previously misspelled word is removed from the Practice list.

Every time a student makes a mistake during this repetition cycle the number of repetitions needed for this particular task should be re-set to three, regardless of how many previous attempts have been completed.

Stopping the repetition cycle of a learning unit that was previously unknown at the first correct answer, as common in traditional learning settings, frequently only rewards the student for their short-term memory skills, not for whether they actually memorize the task successfully and will be able to rely on their knowledge in the future.

Even with the advent of software and Internet opportunities, learning and tutoring materials and similar study units remained fragments, containing limited content selected based on the editor's or publisher's decisions, hereafter referred to as “modules” or “modular units.” They are limited assortments of knowledge designed to support a student's learning for a short while, and then be abandoned as the student moves on.

Most instructional materials focus on the content of one school grade or course.

### Some programs try to expand on this and provide content for a certain proficiency level.

### However, the classification of what content should be included, and what excluded is necessarily random.

Teachers are often presented with a large range of skill levels in their classroom. Teaching struggling and advanced students together with students of average skills results in less than optimal instruction and tutoring for all students, but especially those on both ends of the proficiency spectrum.

Modular units often deprive bright students of the benefits associated with a challenge, since they are likely to already know the majority of material. For example, studies have shown that on average, students know 75% of the words on their weekly spelling word list, but are still required to “study” them. This makes the process boring and frustrating for the student and teacher.

On the other hand, struggling students may still need lower level learning, which is not provided by the module currently used in the classroom. Without extensive intervention, such a student will lose the ability to catch up with the rest of the class and will fall further and further behind.

Prior to the development of this invention, only encyclopedias and reference materials attempted to present a truly comprehensive knowledge base to their users. Although completeness is an abstract goal since in most areas knowledge evolves and changes, such reference materials make an reasonable attempt to provide complete resources.

Prior to our invention, no one has attempted to pair tutoring technology with such a comprehensive knowledge base so that students and teachers would enjoy flexibility, continuity and unlimited resources for their studies.

The current practice of moving from modular unit to unit can easily create gaps in knowledge, especially if publishers are also changed.

This effect is even magnified by the fact that work books or software applications are rarely used to their full extend. Once the term or course ends, the areas not yet explored are left unstudied as the student advances to another unit of study. The fact that study units have an “expiration date” makes them rather unreliable, and prevents them from providing diligent tutoring support. This negatively impacts their success.

By focusing on their own, limited content only, most traditional methods ignore opportunities to engage with the learner in areas outside of the scope of the current study unit. Most programs simply can not accommodate an “add content” module. Random requests can not be accommodated due to the limitations of the underlying database.

For example, a student can not expect to receive help from the traditional software applications with vocabulary encountered while reading a book or a newspaper outside of class.

Brain research has shown that our brain will learn what is useful, interesting and appropriate based on the current knowledge base. Learning becomes effective if users are allowed to add content that is relevant and to choose a study focus that accommodates their personal goals.

Learning is further enhanced by a program that can adjust to a student's skill level, and remembers that user's individual “problem areas.”

Limited study units often don't satisfy the needs of the student. While it is fairly easy to determine which words will be appropriate and important for a second grade student, attempting to make such decisions for an adult language learner is nearly impossible.

Here, the fact that the study program was predetermined by a publisher who does not know the individual situation, experience, skill level and motivation of the learner often results in ineffective and boring instruction which is part of why a lot of the adult language learners abandon the classroom after a few sessions—the tasks presented are not synchronized with the needs of the learner.

Considering how difficult it is for a lot of students to find the time to study, going through a program that is disconnected from their immediate education needs is often not acceptable to the student, and frustrating to the teacher.

In essence, the preferences determined by the needs, goals, skill levels and constellation of problem areas is unique for every student. Only a program that is comprehensive enough to take this into account and custom-tailor itself to a student's needs will be able to produce results quickly and reliably, and fuel the motivation to keep learning.

The main reason why tests have been prevalent in the traditional education is that the teacher does not have sufficient data to verify if the student indeed has studied what needs to be learned sufficiently. Testing can effectively be replaced by a program that provides transparent performance reports, removing any mystery from the learning process.

In addition, most methods look at the test as the concluding step in the study process, whereas it is only of value to the student if follow-up tutoring on areas not yet mastered are included. Tests are only productive if they are used to uncover weaknesses that are then systematically reduced or eliminated via tutoring. This does hardly ever happen within traditional settings.

Students often experience limitations because of location, time availability, timing and the cost of instruction. Low quality or availability of the existing programs in their proximity and/or limited instructor's resources and commitment may further impact the success of students' instruction.

Traditional tutoring often just asks for the core information, without providing supporting information or ways to explore newly learned knowledge in greater depth. With content prescribed by a third party there is limited room to let curiosity roam.

Modern brain research has made a lot of progress over the last few decades, and one of the most important results is that the brain will learn only what it deems to be interesting and useful.

Tutoring success increases with the number of information placed at the disposal of the student—the learning experience becomes more stimulating and entertaining, and allows the student to connect new tasks with knowledge that is interesting and useful for easy memorization. The brain gains a broader, more complex knowledge base, allowing for easier connections to incorporate the new information into the existing knowledge base.

Because of the limited scope of the software content, it only provides tutoring within the content module, and does not allow for content to be added upon demand, thereby not supporting instruction that is customized to the student's needs.

There are many educational software programs on the market, both for installation on an individual computer, server-based or web-based. Many programs even include a customized learning profile to provide customized feedback and instruction to the individual student.

Most of the time the learning profile is primarily used to document the learning results only, or provides a limited number of repetitions. Even if the profile is designed to provide customized, diligent tutoring, it is limited by the fact that it is rooted in a modular learning unit of limited scope that will soon be abandoned and replaced with a new modular unit.

The educational value of the software thereby is limited by the size of the content unit and the length of the tutoring cycle. Once the learner has outgrown the module, the learning profile is no longer useful. Instead of building a comprehensive learning profile, the learning data is abandoned and rendered useless every time the modular unit changes.

It is therefore an object of the invention to provide customized, ongoing and complete tutoring.

It is another object of the invention to provide a comprehensive and as much as possible complete knowledge resource with which to support students' progress through various stages of expertise.

It is another object of the invention to replace modular units of study with a perpetual study program.

It is another object of the invention to register the learning data of each student in their individual User's profile, registering what is learned and what needs further study, along with the student's goals, skill level and preferences.

It is another object of the invention to maintain and update this User's profile throughout the entire learning period, systematically building said User's profile to get more and more refined and comprehensive.

It is another object of the invention to allow that tasks be added to the User's profile for priority study.

It is another object of the invention to provide detailed performance reports of the student's progress.

It is another object of the invention to provide the required number of successful repetitions to anchor the tasks into long-term memory.

It is another object of the invention to allow for the optional use of a back office that would allow teachers and administrators to interact with the User's profile by adding and/or monitoring tasks.

### SUMMARY OF THE INVENTION

In accordance with the present invention, there is provided a perpetual software-application that provides customized, ongoing and potentially unlimited tutoring based on a database designed to provide a complete and comprehensive knowledge base for the area of study and a user database that maintains a personal User's profile triggering continuous individualized learning quizzes based on student's preferences, needs and previous results.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a conceptual flow chart view of a typical prior art tutoring structure using traditional tutoring means or software applications;

FIG. 2 is a conceptual flow chart view of the general structure of the invention, visually expressing the all-encompassing nature of the underlying database and the continuous nature of the tutoring and the User's profile customization;

FIG. 3 is a flowchart view of a typical quiz cycle, with FIG. 3a showing a schematic explanation of how content may be selected based on preference settings and Results table;

FIG. 4 is a flowchart view of the elements that interact with the User's profile; and

FIG. 5 is a flowchart view of a typical repetition schedule.

For purposes of clarity and brevity, like elements and components will bear the same designations and numbering throughout the Figures.

### DESCRIPTION OF THE PREFERRED EMBODIMENT

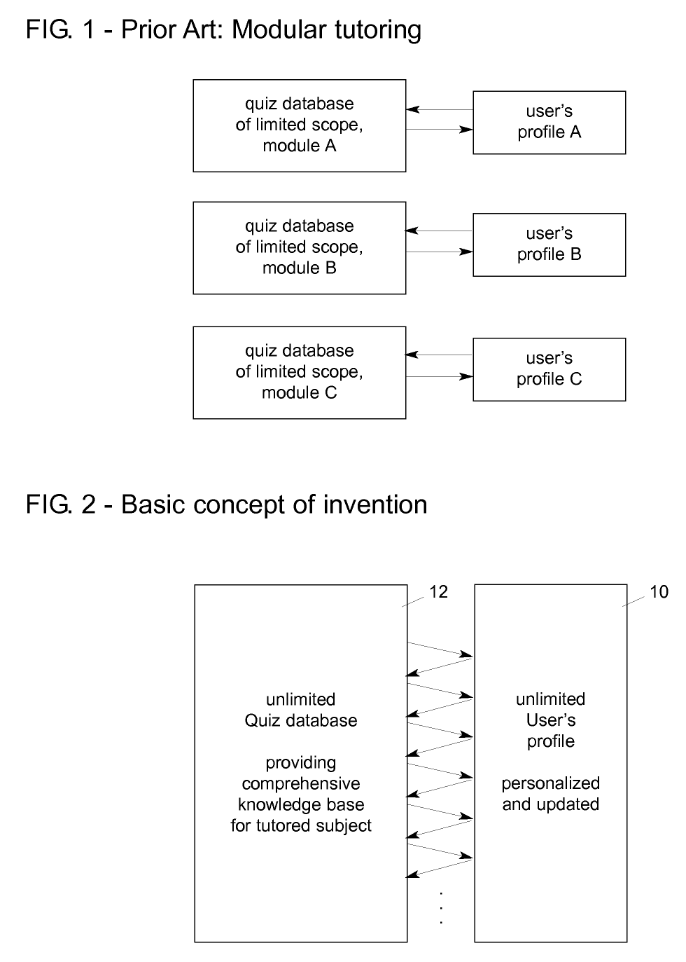

FIG. 1 is a conceptual flow chart view of a typical prior art tutoring structure using traditional tutoring means or software applications. Both the modular knowledge bases used and the student's profile created are limited, and the learning process is interrupted and started anew every time the modular unit is changed.

FIG. 2 is a conceptual flow chart view of the general structure of the invention, visually expressing the comprehensive nature of the underlying Quiz database 12, the continuous nature of the tutoring, and the perpetual customization of the User's profile 10.

Because of the sizes of the underlying databases that support this process, and the long-term learning perspective, this application is greatly suited for the Internet or a similar computer network. However, it is conceivable that such application could be operated from a more localized computer platform as well.

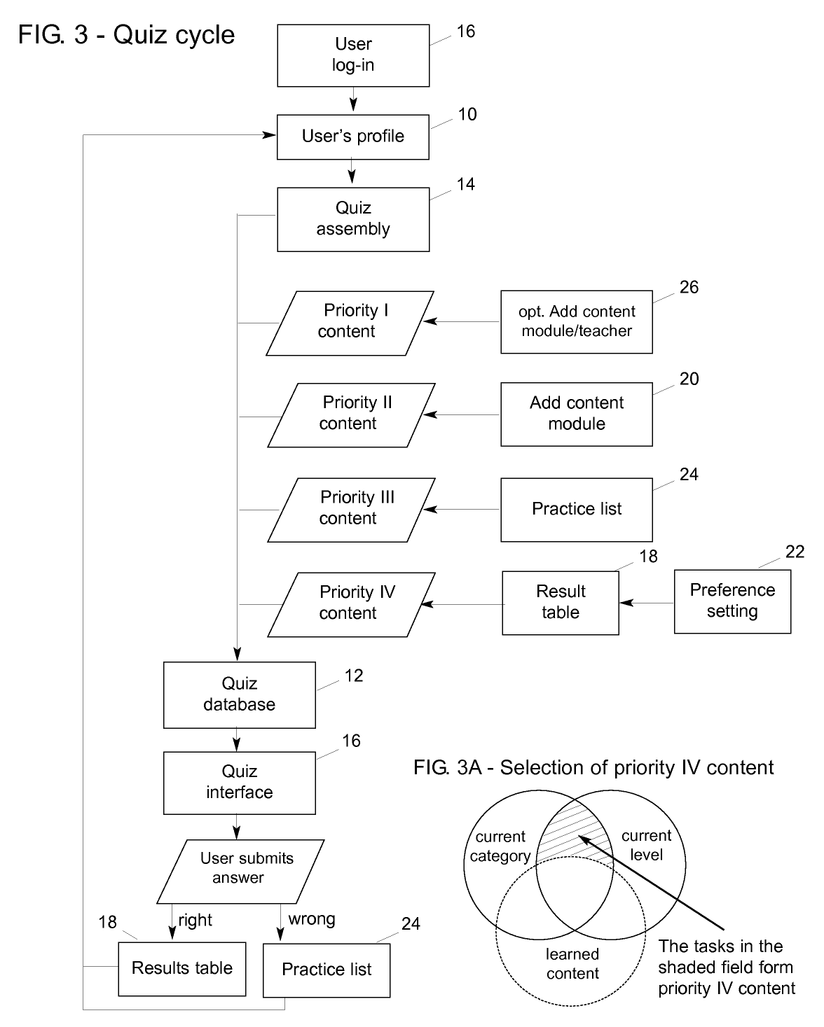

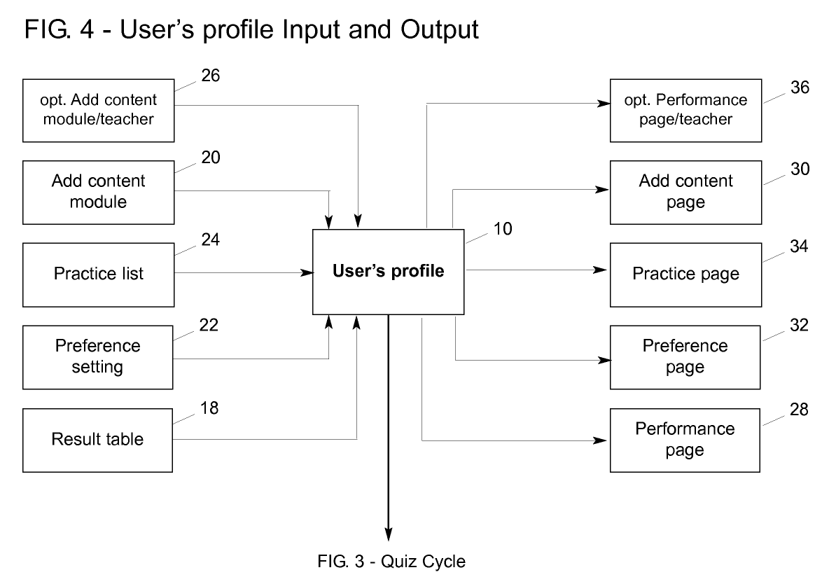

FIG. 3 is a flowchart view of a typical quiz cycle. It displays how the quiz is assembled and conducted after user log-in 8. The User's profile 10 triggers Quiz assembly 14 based on pre-defined priority settings. The scope and order of these priority settings may be changed to accommodate a particular quiz setting. In FIG. 3 we describe the current set-up at http://www.eSpindle.org, but other constellations are possible. The highest priority is given to content added through the optional (from here on short: “opt.”) Add content module/teacher 26.

### After all words submitted by the teacher have been included, the Quiz assembly 14 then includes all tasks added by the student or parent via the Add content module 20.

### Following those entries come words currently on the Practice list 24, followed by tasks selected based on the Preference setting 22 and the Results table 18.

FIG. 3a shows a schematic explanation of how content is selected based on a user's Preference setting 22 and Results table 18.

### Priority IV content includes all those tasks that meet all of the criteria defined on the Preference page 32, and are not contained in the result table as a task already known and are not included in the Practice list 24.

After the Quiz assembly 14 has assorted the tasks for the current quiz session according to these parameters, Quiz database 12 is queried and the list of tasks is sent to the quiz interface 16 along with the supporting data (text, audio, images, etc.)

After the user submits the answer, the results are either stored in the Results table 18 if correct or in the Practice list 24 if in need of further practice. Either way the User's profile 10 is updated with the current record.

FIG. 4 is a flow chart view of the elements that interact with the User's profile 10. On the left hand side are listed some of the possible modules that supply information to the User's profile 10, on the right hand side are listed some of the possible pages that draw information from the User's profile 10 to display to the user, teacher, etc.

This flow chart depicts the modules and pages established for the tutoring processes at http://www.eSpindle.org, but of course, variations of these are possible as the invention is adapted to a certain tutoring setting.

The opt. Add content module/teacher 26 allows teachers to add tasks to a User's profile 10, either individually or by uploading tasks to a group.

### It is recommended that these tasks are incorporated into the quizzes with priority.

The opt. Performance page/teacher 36 on the opposite side displays performance information about individual users or a group of students drawing on each individual User's profile 10. Such information could include number of tasks studied; number of tasks completed correctly, incorrectly, skipped; day, time and duration of learning sessions, etc.

The Add content module 20 allows the user or a parent etc. to upload priority tasks. Such content lists may be provided to ease customization of the program, and users may choose to exchange lists to support each other's learning efforts (“list swap”).

The Add content page 30 on the right hand side of the flowchart is the portal for submitting such tasks, but may also display a table with the priority tasks that have been submitted but that have not yet been presented. The Practice list 24 includes all tasks that were previously answered incorrectly and that need more practice. A list of all tasks that are being repeated to the user is displayed on the Practice page 34, where they can be reviewed, printed or removed from the tutoring cycle if so desired.

The Preference setting 22 may include a range of different preferences, both for the purpose of influencing which content the quiz focuses on as well as the general environment for the quiz sessions. Examples for common preference settings may be category and grade level settings, a sound on/off choice or different quiz layouts (“skins”), among others. The current preference settings are displayed on the Preference page 32 and can here be changed by the user.

The Results table 18 stores all of the tasks that have previously been presented and are now considered “known.” A task may be added to the Results table 18 either because the user entered the correct answer at first attempt, or because a task from the Practice list 24 has been repeated correctly over subsequent quizzes until the pre-defined sequence of correct answers has been achieved.

The Performance page 28 is populated by data from the User's profile 10. It provides information about, for example, the number of tasks completed, the results, the day, time and duration of each quiz etc.

By tracking student performance and allowing students to review and change settings, the User's profile 10 is the central component to determine which tasks are chosen from the Quiz database 12 for the quiz, as described in FIG. 3, Quiz cycle.

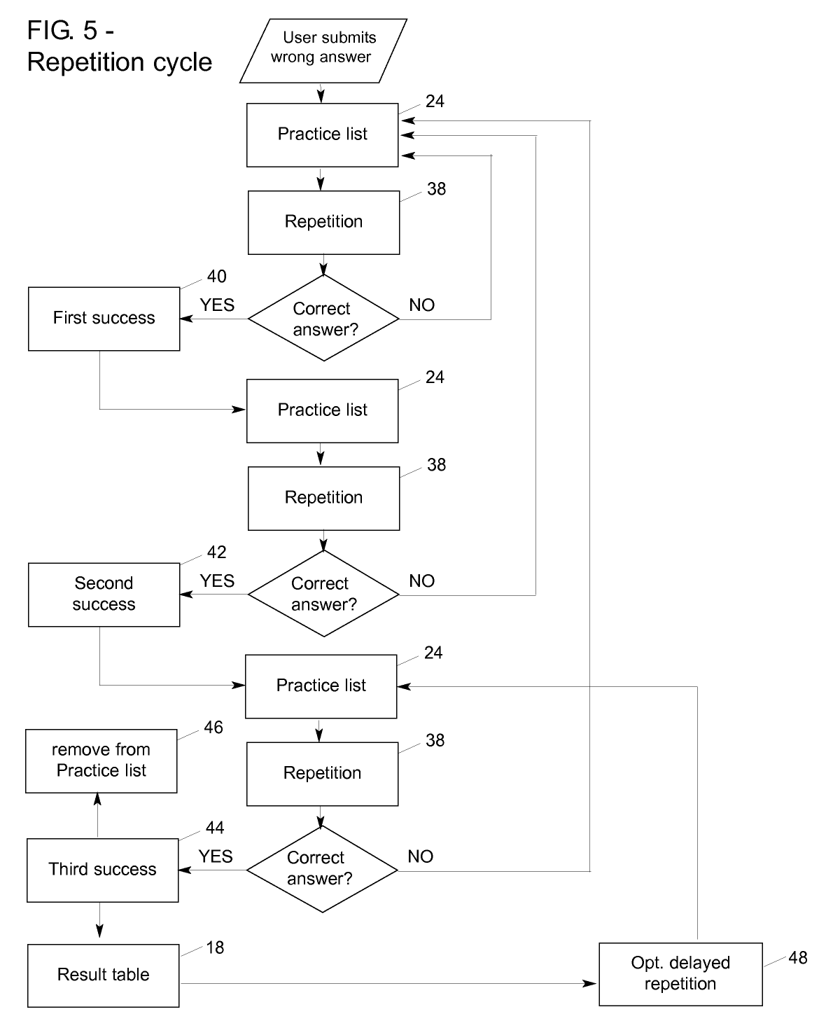

FIG. 5 is a flow chart view of a typical tutoring schedule, as used for the tutoring module at www.eSpindle.org.

The goal of this drawing is to illustrate how the program, being unlimited and continuous in scope, accomplishes to generate the sufficient amount of repetitions for practice tasks, regardless of whether that means three (the minimum in the schedule displayed) or many more repetitions. Requiring a different number of repetitions or creating a different structure in the cycle would be considered variations of this same concept.

As the user submits a wrong answer, the task is added to the Practice list 24 for future tutoring.

At the next opportunity the Practice list 24 will submit the task for Repetition 38. Answering incorrectly will require that the user starts over in the repetition cycle.

If the answer given is correct, this first success 40 is registered in the Practice list 24, leaving two more repetitions to be accomplished successfully before the required three consecutive repetitions are completed.

At the next quiz session, the Practice list 24 will then present a new Repetition 38. Answering incorrectly will require that the user starts over in the repetition cycle.

If the answer given is correct, this second success 42 is registered in the Practice list 24, leaving just one more repetitions to be accomplished successfully before the required three consecutive repetitions are completed.

Answering incorrectly at the third Repetition 38 will, just like at previous stages of the schedule, require that the user starts over in the repetition cycle.

If the third Repetition 38 is answered successfully, however, the third success 44 is registered and results in Practice list removal 46. This task is then added to the result table as “known.” It may further be beneficial to schedule an opt. Delayed repetition 48 to occur after a certain time period, especially for tasks that were answered incorrectly more than once.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A perpetual educational system providing personalized learning sessions for supporting continuous and individualized learning progress based on a comprehensive knowledge based, comprising:
a personalized, continuous, and by its design limitless User's profile, for managing the individual user's records on a continuous and ongoing basis, storing quiz results, added content and preference settings, and providing data to the quiz interface and user pages;
a comprehensive Quiz database, for providing a knowledge foundation that supports the tutoring quizzes through an as much as possible complete set of data from the subject area studied;
an individual User log-in, for providing the user with exclusive access to the User's profile and customized quizzes based on same;
an individualized Quiz assembly, for assembling the data for the current session based on information contained and provided in the User's profile, structuring content based on pre-defined priority criteria and sending queries to the Quiz database to retrieve the data necessary to assemble the quizzes;
an interactive Quiz interface, for presenting the tasks to the user;
a custom Results table, for registering and storing the tasks that are already known by the user;
an optional Add content module, for allowing user to add tasks to the quiz to be studied with priority;
a customizable preference setting, for registering and storing the individual user settings for the quiz and allowing their customization;
an individualized, ongoing Practice list, for managing tasks that need further practice through the program's repetition cycle;
a managed repetition cycle, for repeating content not yet learned in future quizzes at predefined intervals; and
an instant Practice list removal, for removing content that was previously on the Practice list after it has been repeated successfully for the specified number of times.
